(19) United States
(12) Patent Application Publication
(10) Pub. No.: US 2002/0020677 A1
(43) Pub. Date: Feb. 21, 2002

(54) Thermal processing system for farm animal waste

(76) Inventor: Donald C. Noll, Kutztown, PA (US)

Correspondence Address: NIXON & VANDERHYE P.C., 1100 North Glebe Rd., 8th Floor, Arlington, VA, 22201-4714, US

(21) Appl. No.: 09/906,622

(22) Filed: Jul. 18, 2001

Related U.S. Application Data
(60) Provisional application No. 60/218,816, filed on Jul. 18, 2000.

(51) Int. Cl. C02F 1/68

(52) U.S. Cl. 210/766

(57) ABSTRACT

An integrated farm animal waste treatment system for treating solid and liquid farm animal wastes while recovering waste heat energy generated during the treatment process. The preferred embodiment includes a portable chemical treatment process that can be moved from one waste processing site to another in order to treat a variety of different types of animal waste in varying amounts on a batch basis. The preferred embodiment provides for the destruction of hazardous solids, liquids and gases. In addition, the process includes means to isolate and recover valuable by-products of farm animal waste, such as nitrogen and ammonia, for use in manufacturing commercial-grade fertilizer. The preferred embodiment also includes means for capturing waste heat for use either internally in the waste treatment process itself or, alternatively as a source of heat for the farm creating the animal wastes. The same basic process, but with additional, more permanent features, can be installed and operated on either a batch or continuous basis as a permanent installation, depending on the need within a particular farming community.

### BACKGROUND OF THE INVENTION

For generations, a major problem has existed in the United States and around the world with respect to the treatment and disposal of farm animal wastes. The volume of such wastes has been increasing steadily in recent years. In the past, most farms in the United States have relied on waste water lagoons as the principal means to store animal waste. Typically, the lagoons vary in size from less than an acre to more than 25 acres, depending on the type of farm and animal waste involved. The processing of hog excrement, for example, normally involves the use of grated pens that allow solid waste to fall through openings in the grating into small wastewater pits where it is stored until transferred into larger holding lagoons.

Unfortunately, animal waste lagoons tend to leak into underground water systems, and thus present significant health risks in addition to creating an offensive odor. The odor has caused environmentalists and individual land owners to call for a ban on open-air waste (manure) lagoons, or at least strict government regulations, including limitations on when the waste effluent may be sprayed as fertilizer on surrounding fields. The stench intensifies with larger quantities of waste, causes higher ambient air temperature and results in poor air quality in general.

Scientists have also found a link between hog and cattle farm odors and illness in people inhabiting the areas adjacent large hog facilities, such as chronic bronchitis, asthma, chronic sinusitis, and organic dust syndrome. Many such illnesses are believed to be attributable, at least in part, to toxic gases, such as hydrogen sulfide and ammonia associated with animal waste odor. A significant need therefore exists for efficient methods and systems to reduce the amount and/or intensity of odors emanating from hog, cattle, dairy and poultry farm waste lagoons that is both economical and capable of being adapted to different sized farming establishments.

In conventional treatment systems, animal waste normally is broken down in the lagoons by natural anaerobic microorganisms (which causes the foul odors). It has been prohibitively expensive to equip these large lagoons with enough chemical processing equipment to support aerobic microorganisms that release less disagreeable odors and break down the waste solids faster. Other prior art systems depend on indigenous microbes. However, such systems vary in effectiveness, depending on which part of the country they are used.

Other new technologies are now being tested to control animal waste odors and to affect the nitrogen and phosphorus content of the waste solids. These methods include additives to the farm animal diet, separation of solids, chemical processing of the waste solids, composting, catalytic reactors, etc. As one example, researchers at Purdue University have investigated the relationship between manure odor and swine diets and found that reducing the crude protein in the hogs' diet and supplementing it with essential amino acids effectively reduces nitrogen excretion. However, small hog farmers may not be able to afford such a solution or may be unwilling to invest in waste treatment or odor-control technologies that do not add to farm profitability. A new cultured wetlands approach has also been used with limited success to reduce odors using a bacteria spread over the surface of the wetlands to digest the nutrients, antibiotics and heavy metals contained in the manure. Again, however, this approach has proven to be too timely, costly and land consuming to be feasible in many animal farm establishments.

Another recent system called the “Slurry/Master” technology separates the solids from the liquids in hog and cattle manure by adding a chemical to the slurry that causes clumping or flocculation. Once the slurry has been mixed with the flocculents, the solids are separated from the liquids and directed to irrigation pipes. The solids are then processed into fertilizer. Other hog and cattle farms in the far North and Northwestern United States have utilized chopped straw to cover clay-lined manure storage basins in an attempt to reduce odor.

U.S. Pat. No. 5,176,823 shows yet another prior art odor control system which incorporates a conventional hood apparatus over a wastewater settling tank which draws air containing VOCs from the waste into a scrubber. U.S. Pat. No. 5,472,472 describes a process for converting animal waste excrement into ecologically manageable materials. The solids in an aqueous slurry of animal excrement are then precipitated in a solids reactor.

Despite the above developments and improvements in the treatment of farm animal wastes, there remains a significant need in the industry for a method that will effectively treat a wide range of different gases and volatile organic compounds in order to reduce animal waste effluvia and the amount of solid material in animal waste lagoons. The method should also be useable in varying geographical regions and with animal farming establishments of varying size and sophistication.

The need also exists within the farming industry, both in the U.S. and around the world, for an animal waste thermal processing system capable of processing solid and liquid farm waste in an economically and environmentally safe manner. A parallel need exists to improve the air quality on farms in a more economical and effective manner than conventional systems. It would also be beneficial to have waste treatment systems capable of processing farm waste at different geographic locations into commercial products (such as ammonia, nitrogen or other components of fertilizer) in an efficient and more cost-effective manner. Most U.S. farms simply cannot afford to install an animal waste treatment process capable of using farm waste to generate heat. Thus, a need also exits for small, economical waste treatment units that can be used to produce steam, hot water or other heat energy to heat or dehumidify farm buildings or other structures, thereby making even small farms more energy efficient.

Finally, a need exists for systems that can process farm waste and effectively eliminate contaminated air by removing hazardous chemicals and odors and improve the overall quality of emissions to the atmosphere and/or the air being circulated through farm buildings.

### BRIEF SUMMARY OF THE INVENTION

It has now been found that many of the above deficiencies of prior art farm waste treatment systems can be eliminated by the process and apparatus according to the present invention. In particular, the invention provides for an integrated, virtually self-contained, waste treatment system that does not require off-site treatment facilities in order to effectively process a wide variety of farm animal wastes. By virtue of its integrated and thermally efficient design, the invention exhibits much greater processing flexibility relative to the type, amount and location of solid and liquid farm animal wastes to be treated.

The preferred embodiment of the invention includes a portable treatment system that is mobile in nature, i.e., can be moved from one processing site to another, in order to treat the animal waste on an interim basis. The portable animal waste thermal processing system according to the invention provides an invaluable service to small farm operators who do not have the capital to purchase such equipment in the form of a permanent installation. The portable apparatus and method according to the invention could therefore be very important to small farm operators. The system could even be purchased as part of a joint venture with other small farm operators and then moved from farm to farm to process the wastewater and waste solids at each farm as required. In that manner, the small farm owner could receive the same benefits from the technology as the large corporate farm operators but at a much lower individual capital investment. Alternatively, the same basic treatment processes described herein, but with certain additional permanent features, can be installed and operated as a permanent waste treatment facility for use on either a batch or continuous basis depending on the need within a particular farming community.

The present invention also has the capability of processing waste by generating valuable by-products that can be used, for example, to manufacture fertilizer products. As such, the process is more economically attractive because the raw materials for making fertilizer (such as nitrogen and ammonia) can be effectively isolated and captured as part of an integrated operating system. The present invention also allows for waste heat recovery at various points in the process which helps make the entire farm and waste treatment system much more energy efficient.

### BRIEF DESCRIPTION OF THE DRAWINGS

FIG. 1 is a detailed process flow diagram depicting the major pieces of equipment used to perform the waste treatment methods according to the invention, including alternative embodiments (labeled on the figure as “optional” and distinguishable by dotted process lines between major pieces of equipment); and

FIG. 2 is a block flow diagram showing the basic processing steps for treating farm animal waste in accordance with the invention, showing the same basic and optional processing steps as depicted in FIG. 1.

### DETAILED DESCRIPTION OF THE INVENTION

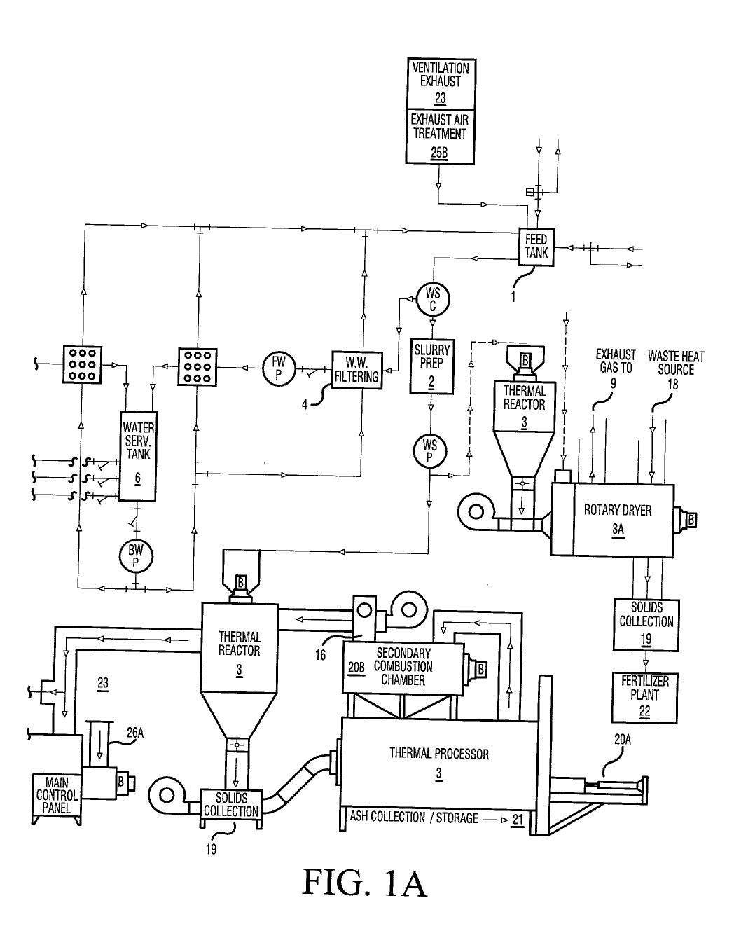

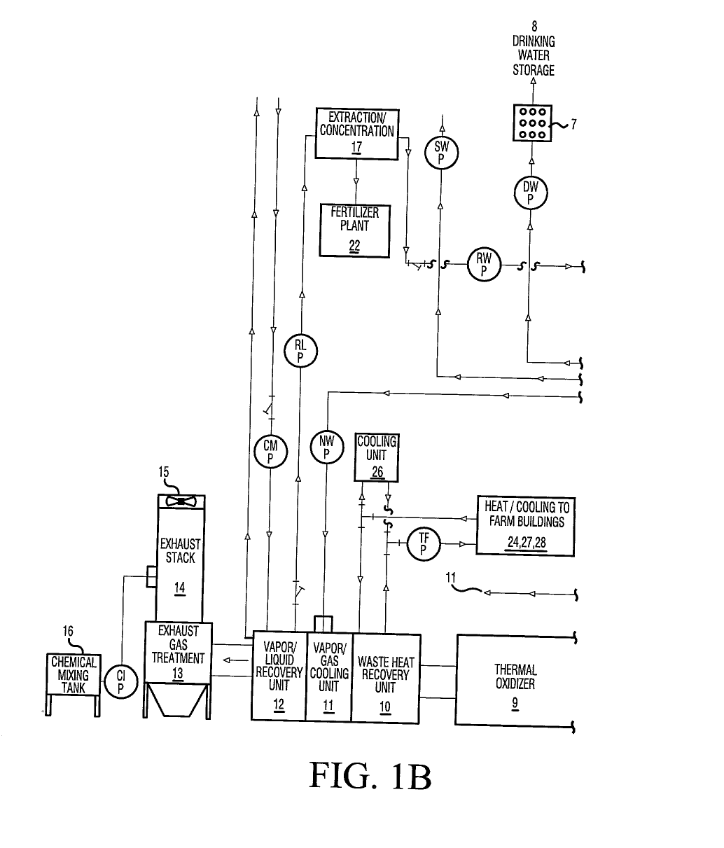

With respect to FIG. 1 of the drawings, animal waste solids and wastewater from farm buildings and structures, lagoons, holding tanks, animal pens, breeding pens and other areas where animals are located are delivered to a wastewater/solids feed tank 1. In the feed tank, solids are broken up and de-lumped then mixed with the wastewater to a consistent mixture. Additional water may be added if required to adjust the solids content and viscosity. The wastewater/solids mixture is then transferred to slurry preparation unit 2.

The wastewater/solids mixture enters the slurry preparation unit 2 where water is removed by one or more separators and/or centrifuge(s) in order to increase the solids to liquid ratio. The ratio is controlled by measuring the density and viscosity of the discharged slurry and adjusted via the control system to any desired ratio within the system design range. The separator and/or centrifuge unit(s) typically incorporate automatic backwashing capabilities to reduce the possibility of blockage during operation. The backwashed water is returned to slurry preparation unit 2 for reprocessing. After processing, the slurry is transferred to a thermal reactor unit 3 or, alternatively, to a combination thermal reactor/rotary dryer unit (designated as 3A).

The slurry discharged from slurry preparation unit 2 enters the thermal reactor unit 3 via atomizing nozzle(s) at the top of the unit and then discharged into the thermal reactor chamber where the remaining water is removed by a conventional thermal diffusion process. A combination thermal reactor/rotary dryer unit 3A can be used to process high-density waste solids.

Wastewater separated from the wastewater/solids mixture via the slurry preparation unit 2 is transferred to a filtering unit or system 4 that removes fine solids from the wastewater. The types of filters utilized incorporate automatic backwashing capabilities to reduce the possibility of blockage during operation. The backwashed water is then returned to the slurry preparation unit 2 for reprocessing. After filtering, the wastewater is transferred to a wastewater treatment unit 5 for further processing. The type of equipment and methods employed for treating the wastewater will vary depending on the analysis of the wastewater.

Water processed through the wastewater treatment unit 5 is then transferred to a wash down water service tank or main wash down water storage tank 6. The processed water may be used for wash down and cleansing of animal pens, farm buildings or structures, recharging of pits, flushing, etc. The continuous recycling of wastewater conserves water from fresh water wells and other water resources and prevents possible soil and ground water contamination due to spraying or spreading the waste solids/wastewater mixture onto and into the soil or land.

Water from the wash down water service or main storage tanks 6 is transferred to a drinking water treatment unit to system 7 where it is processed to produce water suitable for consumption by the farm animals. Again, the exact type of equipment and methods employed for treating the wash down water will vary depending on the analysis of the wash down water. The drinking water produced by the drinking water treatment unit to system 7 is transferred to a service tank and/or main storage tank 8.

Gases/vapors exiting the thermal reactor 3 (or exiting from the combination thermal reactor/rotary dryer 3A) may include some hazardous components such as methane, hydrogen sulfide, VOCs, etc. which could be detrimental to the environment and be harmful to humans and animals. Thus, the gases/vapors exiting the thermal reactor 3 are delivered to a thermal oxidizer unit or system 9 where these hazardous components are destroyed by incineration at temperatures ranging from 1100°F.-3000° F.

Gases/vapors exiting the thermal oxidizer 9 are then transferred to a waste heat recovery unit or system 10 where some of their waste heat is transferred to pre-heat air, produce steam and/or hot water or to heat a chemical based heat transfer fluid. This recovered heat may also be utilized to heat or dehumidify farm buildings or structures, heat storage tanks and silos, provide heat to an evaporator or concentrator process 17, or provide heat to equipment or systems to prevent freezing. The same waste heat can also be used to improve animal comfort within farm structures. Gases/vapors exiting the waste heat recovery unit or system 10 are transferred to a gas/vapor cooling unit or system 11 where the temperature of the gases/vapors is rapidly reduced. This rapid reduction in temperature lessons the possibility of furan and dioxin component formation that could affect the environment.

Gases/vapors exiting the gas/vapor cooling unit or system 11 are transferred to a vapor/water recovery unit or system 12 where the vapors are condensed into a liquid. The recovered liquid is collected and transferred to the wastewater treatment unit or system 5 where it is processed and then transferred to the wash down water service tank or main wash down water storage tank 6.

Gases exiting the vapor/water recovery unit or system 12 are transferred to an exhaust gas treatment unit or system 13 and then exhausted through a stack 14, via an exhaust fan 15, to the atmosphere. Additional treatment of the exhaust gases may be required, depending on the analysis of the exhaust gases and may be provided by incorporating an exhaust gas monitoring, control and a chemical treatment unit or system 16.

The previously described process may be modified in order to separate and recover certain chemical components such as ammonia, nitrogen, etc. for use in the manufacture of fertilizer or for use in other processes and industries. The modifications consist of bypassing the thermal oxidizer unit 9 and waste heat recovery unit 10 and directing the gases/vapors exiting the thermal reactor unit 3 (or the combination thermal reactor/rotary dryer unit 3A) directly to the gas/vapor cooling unit 11. The gases/vapors pass through the gas/vapor cooling unit 11 and enter into the vapor/water recovery unit 12 where they are condensed and captured in the recovered liquid. The recovered liquid is transferred to an evaporation, distillation and/or concentration process unit 17 where the various chemical components are extracted and/or concentrations increased. This process produces aqueous ammonia, ammonium nitrate, etc. for use in the manufacture of ammonium nitrate-based fertilizers and/or as starting ingredients in the production of other commercial products. The chemicals recovered from this process are transferred to a fertilizer manufacturing facility 22 or other processing operation and the water recovered from the process is transferred to the wastewater treatment unit 5 for processing as described above.

Solids exiting from the thermal reactor unit 3 (or from a combination thermal reactor/rotary dryer unit 3A) are collected in a service bin 19 and transferred to a thermal processor 20 where they are destroyed. The heat produced by their destruction is recovered and used as a heat source for the thermal reactor unit 3 or a combination thermal reactor/rotary dryer unit 3A, thus reducing primary fuel usage. The resulting ash and residue, which is relatively inert, can be removed and transferred to a landfill 21 or other suitable disposal facility.

Deceased animals, afterbirth, carcasses, etc. are transferred to a thermal processor unit 20 where they are inserted/charged, via a ram type loader/feeder unit 20A designed specifically for single or multiple animal insertions, and then destroyed by incineration. Heat produced by the destruction of the deceased animals and wastes is recovered and utilized to provide a heat source for the thermal reactor unit 3 or for a combination thermal reactor/rotary dryer 3A. The remaining ash and residue, approximately 1-5% of initial volume or weight, can be removed from the thermal processor unit 20 and transferred to a landfill 21 or other suitable disposal facility.

Heat is recovered from the thermal processor 20 via an exhaust gas to air heat exchanger unit 18 or by mixing the hot exhaust gases directly with the fresh air supply for the thermal reactor unit 3 or a combination thermal reactor/rotary dryer unit 3A. Heat may also be supplied to the thermal reactor unit 3 or a combination thermal reactor/rotary dryer 3A fresh air supply via a heat exchanger utilizing steam, hot water or a chemical based heat transfer fluid supplied by the waste heat recovery unit 10.

The previously described process shown in FIG. 1 may be modified so that the solids, exiting the thermal reactor unit 3 or exiting a combination thermal reactor/rotary dryer unit 3A, are collected in a collection bin 19 and saved. The recovered solids, which contain phosphate and other minerals, are removed from the collection bin 19, stored and then transferred to a fertilizer manufacturing facility 22 where they may be combined with other materials to produce high analysis type fertilizers.

The above system may be manufactured and installed in one of two ways, either as a centralized, stand alone stationary system that incorporates all of the previously described features and equipment, or integrated with existing farm equipment and air control systems to improve the farm building or structure internal air quality, reduce contaminated air and odor emissions and utilize recovered waste heat from the animal waste thermal processing system.

As illustrated in FIG. 1, odor and hazardous gases; such as ammonia, methane, hydrogen sulfide, VOCs laden air is exhausted from the farm building or structure via a single exhaust fan system 23 powered by an electric motor utilizing a variable speed drive motor control unit. The exhaust air control damper unit also incorporates a variable position type damper and control modulating motor.

Multiple sensors, measuring hazardous gas levels and contents, building/room temperature(s) and building/room humidity levels, are located throughout the farm building(s) or structure(s). These sensors transmit signals to a master control system 28 which analyzes the signals then controls the speed of the exhaust fan motor, via the variable speed motor control unit and/or controls the position of the exhaust air control damper thus controlling the volume of air and the flow rate of air exiting the farm building or structure.

A master control system 28 controls the temperature and humidity levels of the air entering and within the farm building(s) or structure(s) by transmitting signals to control valves, dampers and/or controls located on the waste heat recovery unit or system 27 and on the fresh air supply unit or system 24 so that desired levels are maintained automatically.

Heating of the farm building(s) or structure(s) can be accomplished by incorporating an air to liquid heat exchanger(s) utilizing steam, hot water or a chemical based heat transfer fluid supplied by the waste heat recovery unit or system 10 located on the animal waste thermal processing system. The temperature of farm building(s) or structure(s) are controlled by the master control system 28.

Farm building or structure internal air laden with odor, hazardous gases; ammonia, methane, etc. and VOCs can be removed by the previously described exhaust fan system and discharged into an exhaust air treatment unit or system 25. Two alternative methods may be utilized to treat the exhausted air laden with hazardous gases, odors, VOCs, fumes and vapors. Method 25A is a high temperature incineration method which utilizes the thermal oxidizer unit or system 9 located on the animal waste thermal processing system. Exhausted contaminated air, exiting from the farm building(s) or structure(s), is discharged into ductwork connected to the thermal oxidizer unit or system 9. The exhausted contaminated air enters the thermal oxidizer unit or system 9 where the hazardous gases, odors, VOCs fumes and vapors are destroyed by high temperature incineration. A variation of this system utilizes packaged thermal oxidizer units or systems at individual farm buildings or structures.

Method 25B is an absorption method that utilizes a spray type gas absorption tower. Exhausted air, exiting from the farm building(s) or structure(s), laden with hazardous gases; ammonia, methane, etc., odors, VOCs, fumes and vapors, is discharged, from the previously described exhaust fan system 23 into a spray type absorption tower. The gas laden air is slowed and impacted with fine sprays of water. Since the majority of the gases are highly soluble in water, they combine with the sprayed water by absorption and become captured in the water. The water with the captured gases falls to the bottom of the spray tower unit where it is collected and pumped to the animal waste thermal processing system where it is processed in the same manner as the wastewater processing previously described.

Additional chemicals may be incorporated to enhance the absorption process and to prevent system freeze up during cold climate conditions. Utilization of dry or wet type filter media unit(s) or system(s) to treat the contaminated exhaust air before it exits the farm building or structure or before it enters the spray type absorption tower, or even before it exits the spray type absorption tower may be required depending on the chemical analysis of contaminated exhaust air. The spray type absorption tower incorporates a chemical based heat transfer fluid heat exchanger to reduce the possibility of freeze up during cold climate conditions. The heat source for the system will be the waste heat recovery unit 10 located on the animal waste thermal processing system.

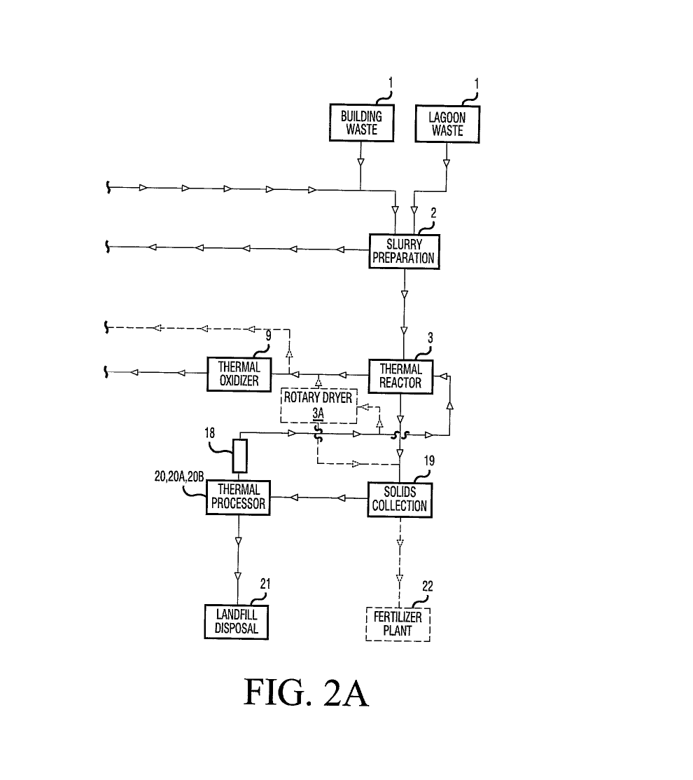

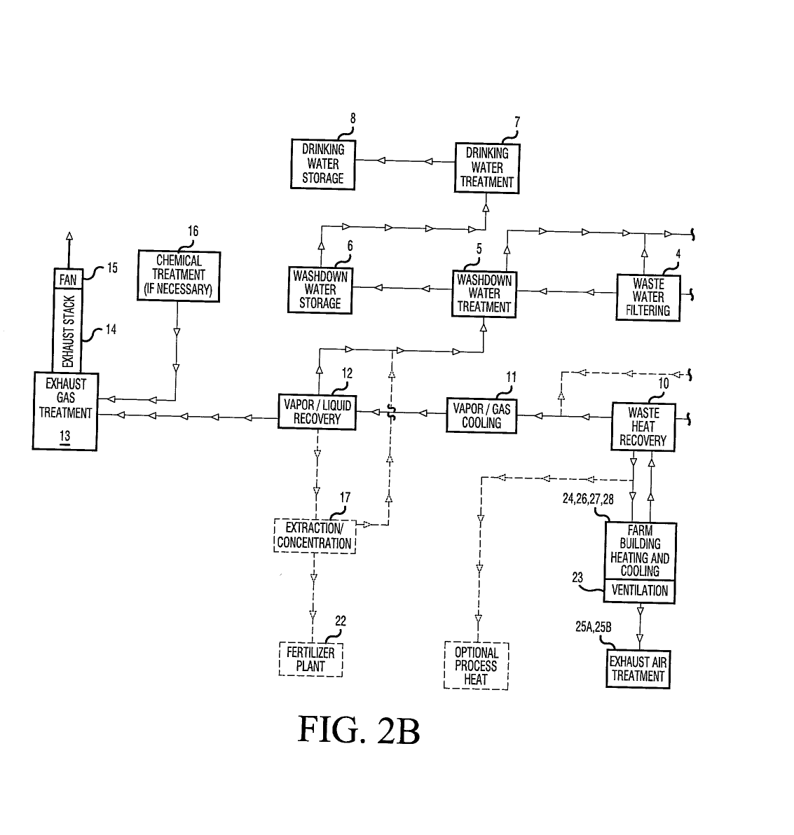

Referring to the block flow diagram of FIG. 2, the normal process steps according to the invention are depicted by a solid line connecting the individual steps, while the optional process described above in connection with FIG. 1 are shown in a dotted line configuration. The numerical designations for the various process steps shown in FIG. 2 match those discussed above with respect to FIG. 1.

As those skilled in the art will appreciate, the portable animal waste thermal processing system in accordance with the invention is designed to process wastewater and waste solids only. Thus, the previously described equipment and systems included in items 10, 23, 24, 25A, 25B, 26, 27 and 28 may not be necessary, depending on the exact end uses and costs contemplated. Regardless of the end use, however, the portable animal waste thermal processing system according to the invention can be provided as a complete self-contained operating system mounted or installed on a truck, trailer, skid or sled and incorporates all of the equipment and features utilized in the stationary system except as previously noted. A fossil fuel powered engine driven generator supplies power to all of the systems electric motors, controls, pups, fans, air compressor, centrifuges, mixers, etc. All operations, methods, functions, etc. are identical to the stationary system previously described. The portable animal waste thermal processing system incorporates primary fuel tanks, water storage thanks, solids holding bins, etc. which are an integral part of the truck, trailer, skid or sled construction.

This type of portable animal waste thermal processing system can be extremely important to the small farm operator because an entire system could be purchased as part of a joint venture with other small farm operators. The system could also be moved from farm to farm processing the wastewater and waste solids at each farm as required. The small farm operator would thereby receive the same benefits from the technology as the large corporate farm operators but at a lower individual capital investment. Further, new business ventures could be formed utilizing the animal waste thermal processing system technology. By purchasing portable animal waste thermal processing systems an outside company could provide a service to small farm operators who do not have the capital to purchase such equipment.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A process for treating solid, liquid and gas streams resulting from farm animal wastes, comprising the steps of:
adjusting the solids content of an incoming stream of solid and liquid farm animal waste stream by removing water and creating a wastewater/solids slurry;
treating the wastewater/solids slurry using a thermal diffusion process to remove water vapor and separate the wastewater and solids into separate streams for further treatment;
filtering and chemically treating the separated wastewater to remove certain hazardous dissolved chemicals;
thermally treating the separated solids to oxidize and destroy additional hazardous chemicals;
recovering a portion of the waste heat generated during said thermal treatment;
treating through absorption the vapor exhaust emissions from said thermal treatment to remove additional vapor contaminants; and
disposing of solid wastes generated during said thermal treatment.

2. The process according to claim 1, further comprising the step of bypassing said thermal treatment step and diverting said solids stream resulting from said thermal diffusion to a solids dryer for recovery of ammonia nitrate and other nitrogen-based compounds used in the manufacture of fertilizer.

3. The process according to claim 1, wherein said step of thermally treating said separated solids includes the step of incinerating the solids in a thermal oxidizer.

4. The process according to claim 1, the step of adjusting the solids content of said incoming stream includes passing the incoming stream through a centrifuge.

5. The process according to claim 1, wherein said thermal diffusion process includes a thermal reactor to vaporize water from said incoming slurry stream.

6. The process according to claim 1, wherein the hazardous chemicals removed during said thermal treatment step include ammonia, urea, aldehydes, hydrogen sulfides and methane.

7. The process according to claim 1, wherein the step of treating said wastewater/solids slurry using thermal diffusion is carried out at gas temperatures ranging from 1,000° F. to 3000° F.

8. The process according to claim 1, wherein said step of recovering a portion of the waste heat further comprises the step of producing hot air, steam, hot water or heating of a chemical-based heat transfer fluid to supply heat energy to farm buildings, animal pens or other farm structures or for the purpose of producing electricity.

9. The process according to claim 1, wherein the step of filtering and chemically treating said wastewater creates a water stream for use in cleaning and washdown of farm buildings, animal pens, breeding pens and other farm structures.

10. The process according to claim 1, wherein the step of thermally treating said separated solids stream includes passing said solids through a secondary combustion chamber to further destroy chemical contaminants.

11. An apparatus for treating solid, liquid and gas streams resulting from farm animal wastes in order to provide raw materials for use in the manufacture of fertilizer and to provide recoverable waste heat energy, comprising:
a centrifuge for removing water from an inlet stream of solid and liquid farm animal wastes to produce a wastewater slurry having a higher solids to liquid ratio;
filtering and purification means for removing fine solids and chemical impurities from said wastewater slurry;
a spray type thermal reactor capable of removing water from said slurry by a thermal diffusion process;
a thermal oxidizer capable of destroying hazardous chemicals present in the gas stream generated by said thermal reactor;
a thermal processor for burning the solids stream exiting from said thermal reactor and oxidizing hazardous chemicals into environmentally safe constituents;
waste heat exchange means for recovering heat generated by said thermal oxidizer; and
liquid and gas absorption units for treating said exhaust from said thermal oxidizer to remove additional contaminants in both gas and liquid waste streams.

12. The apparatus according to claim 11, further comprising means for bypassing said thermal oxidizer and directing said solids stream from said thermal reactor directly to a dryer unit to recover ammonium nitrate, phosphate and other chemical compounds.

13. The apparatus according to claim 11, further comprising a portable unit capable of being transported, installed and operated at different farm locations.

14. The apparatus according to claim 11, further comprising a pneumatic conveying system for delivering and injecting solids from said thermal reactor into said thermal oxidizer.

15. The apparatus according to claim 11, wherein said waste heat exchange means includes heat exchangers and condensers for condensing gases exiting from said thermal reactor.

16. The apparatus according to claim 11, wherein said thermal reactor is a spray type reactor.

17. The apparatus according to claim 11, further comprising a secondary combustion chamber downstream from said thermal oxidizer to further destroy chemical contaminants in said separated solids waste stream.

18. The apparatus according to claim 11, further comprising a spray type cyclone tower to absorb and remove hazardous gases from said thermal oxidizer.

19. An apparatus for treating solid, liquid and gas streams resulting from farm animal wastes in order to provide raw materials for use in the manufacture of fertilizer and to provide recoverable waste heat energy, comprising:
means for monitoring and adjusting the density and viscosity of an incoming stream of solid and liquid farm animal waste stream to create a treatable wastewater/solids slurry;
means for thermally treating the wastewater/solids slurry in order to remove water by a thermal diffusion process;
means for separating the wastewater and solids into separate streams for further treatment;
means treating the separated wastewater to remove hazardous dissolved chemicals;
thermal oxidizer means for treating the separated solids in order to destroy additional hazardous chemicals in said solids stream;
means for recovering a portion of the waste heat generated during treatment using said thermal oxidizer;
means for scrubbing the exhaust emissions from said thermal oxidizer; and
means for disposing of the incinerated solid wastes in ash form.

20. The apparatus according to claim 19, further comprising means for bypassing said thermal oxidizer and directing said solids stream from said thermal reactor directly to a dryer unit to recover substantially pure ammonia and ammonia nitrate.
